(19) United States
(12) Patent Application Publication
(10) Pub. No.: US 2026/0152632 A1
(43) Pub. Date: Jun. 4, 2026

(54) RUBBER COMPOSITION AND HOSE

(71) Applicant: THE YOKOHAMA RUBBER CO., LTD., HIRATSUKA-SHI, KANAGAWA (JP)

(72) Inventors: Koki SUGIHARA, HIRATSUKA-SHI, KANAGAWA (JP); Aya SATO, HIRATSUKA-SHI, KANAGAWA (JP); Atsushi KIKKAWA, HIRATSUKA-SHI, KANAGAWA (JP)

(21) Appl. No.: 19/108,994

(22) PCT Filed: Jul. 20, 2023
(86) PCT No.: PCT/JP2023/026655

§ 371 Date: Mar. 5, 2025

(30) Foreign Application Priority Data
Sep. 8, 2022 (JP) 2022-142938

(51) Int. Cl. C08L 23/16; C08K 3/06; F16L 11/08

(52) U.S. Cl. CPC C08L 23/16; C08K 3/06; C08L 2312/00; F16L 11/085

(57) ABSTRACT

An object of the present invention is to provide a rubber composition and a hose. When the rubber composition is formed into a cured product, the cured product exhibits excellent elongation at break, hardness and ozone resistance. The present invention relates to a rubber component and a hose formed by using the rubber composition, the rubber component containing 40 mass % or more of an ethylene-propylene-non-conjugated diene copolymer containing a diene amount of 6 mass % or more and an ethylene-ethylene chain structure content of 35.0 mol % or more; carbon black; and sulfur.

### TECHNICAL FIELD

The present invention relates to a rubber composition and a hose.

### BACKGROUND ART

A rubber composition containing an ethylene-propylene-non-conjugated diene copolymer or the like has been proposed.

For example, Patent Document 1 describes a sealing member for a fuel cell, which is used for sealing a constituent member of a fuel cell and is formed of a crosslinked body of a rubber composition, in which the rubber composition contains the following (A) and (B):
(A) a rubber component formed of an ethylene-propylene rubber and/or an ethylene-propylene-diene rubber having an ethylene-ethylene diad distribution of 29 mol % or less; and
(B) a crosslinking agent formed of an organic peroxide.

### CITATION LIST

### Patent Documents

Patent Document 1: JP 2014-192107 A

### SUMMARY OF INVENTION

### Technical Problem

When a rubber composition containing an ethylene-propylene-non-conjugated diene copolymer or the like is used for a hose, a cured product obtained from the rubber composition is required to have a high elongation at break (improved hose flexibility and improved hose mounting workability) and a high hardness (leading to improved metal fitting mountability). However, the high elongation at break and high hardness of the cured product can be mutually exclusive, and it has been difficult to achieve both on a high level simultaneously.

When the rubber composition is used for an outer layer of a hose, the outer layer of the hose is required to have ozone resistance.

The present inventors refereed to Patent Document 1 and evaluated a cured product that can be obtained by vulcanizing a rubber composition by using an ethylene-propylene-diene rubber having a low proportion of an ethylene-ethylene diad distribution, the rubber composition containing the ethylene-propylene-diene rubber, carbon black, and sulfur and found that the cured product does not necessarily satisfy the elongation at break, hardness, or ozone resistance required for a hose in some cases.

An object of the present invention is to provide a rubber composition in which, when formed into a cured product, the cured product exhibits excellent elongation at break, hardness and ozone resistance.

Furthermore, another object of the present invention is to provide a hose.

### Solution to Problem

As a result of intensive studies to solve the issues described above, the present inventors have found that a rubber composition containing a rubber component having a specific amount of an ethylene-propylene-non-conjugated diene copolymer having a specific diene amount and a specific ethylene-ethylene chain structure content, carbon black, and sulfur, can achieve desired effects, and thus have completed the present invention.

According to Patent Document 1, when the ethylene-ethylene diad distribution of the ethylene-propylene-diene rubber or the like is more than 29 mol %, the ethylene chain becomes longer, whereby orienting the polymer main chain, which makes it easy to form a crystal structure. Based on this, it was expected that, when an ethylene-propylene-diene rubber having an ethylene-ethylene diad distribution of more than 29 mol % is used, the elongation at break of the resulting cured product will be lower than when an ethylene-propylene-diene rubber having an ethylene-ethylene diad distribution of less than the above is used.

However, the present inventors have found that, when the ethylene-ethylene chain structure content of the ethylene-propylene-non-conjugated diene copolymer is 35.0 mol % or more, the elongation at break is improved contrary to the above-mentioned expectation.

An embodiment of the present invention is based on the findings described above, and to be more specific, it is to solve the issues described above by the following configurations.

[1]A rubber composition, including:
a rubber component containing 40 mass % or more of an ethylene-propylene-non-conjugated diene copolymer having a diene amount of 6 mass % or more and an ethylene-ethylene chain structure content of 35.0 mol % or more;
carbon black; and
sulfur.

[2] The rubber composition according to [1], wherein a molar ratio of the ethylene-ethylene chain structure to an ethylene-propylene chain structure of the ethylene-propylene-non-conjugated diene copolymer is 1.0 or more.

[3] The rubber composition according to [1] or [2], wherein an entire amount of the rubber component is the ethylene-propylene-non-conjugated diene copolymer.

[4] The rubber composition according to any one of [1] to [3], wherein
a content of the carbon black is 70 parts by mass or more relative to 100 parts by mass of the rubber component, and
a content of the sulfur is 0.65 parts by mass or more relative to 100 parts by mass of the rubber component.

[5] The rubber composition according to any one of [1] to [4], which is for a hose.

[6]A hose formed by using the rubber composition according to any one of [1] to [4].

[7] The hose according to [6], which is for an air conditioner.

[8] The hose according to [6] or [7], including an outermost layer formed by using the rubber composition.

### Advantageous Effects of Invention

According to the present invention, it is possible to provide a rubber composition in which, when formed into a cured product, the cured product exhibits excellent in elongation at break, hardness, and ozone resistance, and a hose formed by using the rubber composition.

### BRIEF DESCRIPTION OF DRAWINGS

FIG. 1 is a schematic perspective view illustrating an example of a hose according to an embodiment of the present invention with each layer cut out.

### DESCRIPTION OF EMBODIMENTS

Embodiments of the present invention will be described in detail below.

In the present specification, a numerical range represented by using “(from) . . . to . . . ” in the present specification means a range including numerical values described before and after the preposition “to” as a lower limit value and an upper limit value.

In the present specification, unless otherwise specified, a substance corresponding to each component may be used alone or in combination of two or more thereof. In a case where a component contains two or more types of substances, a content of the component means the total content of the two or more types of substances.

Each component used in an embodiment of the present invention is not particularly limited as to the manufacturing method thereof. Examples of the manufacturing method include a known method.

In the present specification, the case where at least one of elongation at break, hardness or ozone resistance is more excellent is referred to as “achieving more excellent effect of the present invention” in some cases.

### Rubber Composition

The rubber component according to an embodiment of the present invention is a rubber composition including:
a rubber component containing 40 mass % or more of an ethylene-propylene-non-conjugated diene copolymer having a diene amount of 6 mass % or more and an ethylene-ethylene chain structure content of 35.0 mol % or more;
carbon black; and
sulfur.

In the present specification, the ethylene-propylene-non-conjugated diene copolymer having the above-described specific diene amount and ethylene-ethylene chain structure content is also referred to as a “specific EPDM”.

In addition, the specific EPDM and ethylene-propylene-non-conjugated diene copolymers other than the specific EPDM are collectively referred to as an “EPDM”.

The EPDM is a copolymer including a constitutional unit derived from ethylene, a constitutional unit derived from propylene, and a constitutional unit derived from a non-conjugated diene.

The rubber composition according to the present invention is thought to achieve desired effects as a result of having such a configuration. Although the reason is not clear, it is assumed to be as follows.

That is, it is considered that, since crystallinity is imparted due to the ethylene-ethylene chain structure content of the specific EPDM being 35.0 mol % or more, the hardness of the cured product obtained by curing the rubber composition according to an embodiment of the present invention is increased. Meanwhile, the structure of the specific EPDM at the time of elongation affects the elongation at break of the cured product, and therefore it is considered that the crystallinity of ethylene in the specific EPDM is released at the time of elongation, that only the conjugated diene component can be partially crosslinked by sulfur due to an amount of a non-conjugated diene component in the specific EPDM being 6 mass % or more, resulting in excellent high elongation at break. The specific EPDM has no double bond in its main chain, and thus has high weather resistance.

Each of the components contained in the rubber composition according to an embodiment of the present invention will be described in detail below.

### Rubber Component

In the rubber composition according to an embodiment of the present invention, the rubber component contains an ethylene-propylene-non-conjugated diene copolymer (specific EPDM) having a diene amount of 6 mass % or more and an ethylene-ethylene chain structure content of 35.0 mol % or more.

In the rubber composition according to an embodiment of the present invention, by containing the specific EPDM, excellent effect of the present invention can be achieved.

### Specific EPDM

The specific EPDM included in an embodiment of the present invention is an ethylene-propylene-non-conjugated diene copolymer having a diene amount of 6 mass % or more and an ethylene-ethylene chain structure content of 35.0 mol % or more.

Ethylene and propylene constituting the specific EPDM are not particularly limited.

### Non-Conjugated Diene

The non-conjugated diene constituting the specific EPDM is a compound having two non-conjugated double bonds.

Examples of the non-conjugated diene include non-conjugated dienes having a chain structure (having no cyclic structure) such as 1,4-hexadiene; and non-conjugated dienes having a cyclic structure (which may further have a chain structure) such as 5-ethylidene-2-norbornene and 5-vinyl-2-norbornene. Among them, the non-conjugated diene is preferably a cyclic non-conjugated diene, and more preferably 5-ethylidene-2-norbornene (ENB) or 5-vinyl-2-norbornene.

### Diene Amount

The specific EPDM has a diene amount of 6 mass % or more.

In an embodiment of the present invention, the diene amount means a content of a constitutional unit derived from a non-conjugated diene contained in the specific EPDM.

In an embodiment of the present invention, the diene amount of the specific EPDM is 6 mass % or more in the specific EPDM.

The diene amount of the specific EPDM is preferably from 6 to 12 mass %, and more preferably from 6.5 to 10.0 mass % in the specific EPDM, from the viewpoint of achieving more excellent effect of the present invention.

### Ethylene-Ethylene Chain Structure

In general, a unit of two consecutive monomers in a polymer is referred to as diad.

Examples of the diad that the EPDM may have include an ethylene-ethylene chain structure, an ethylene-propylene chain structure, and a propylene-propylene chain structure.

The specific EPDM has an ethylene-ethylene chain structure.

The ethylene-ethylene chain structure is a structure (unit) including two continuous repeating units of ethylene.

### Ethylene-Ethylene Chain Structure Content (EE Amount)

The ethylene-ethylene chain structure content (hereinafter also referred to as “EE amount”) is 35.0 mol % or more.

The EE amount is preferably from 35.0 to 65.0 mol %, and more preferably from 45.0 to 55.0 mol %, from the viewpoint of achieving more excellent effect of the present invention.

### Reference of Ethylene-Ethylene Chain Structure Content (EE Amount)

In an embodiment of the present invention, the ethylene-ethylene chain structure content (EE amount) is a percentage based on a total amount (mol) of the ethylene-ethylene chain structure content (EE amount), an ethylene-propylene chain structure content (EP amount), and a propylene-propylene chain structure content (PP amount). The same applies to the EP amount and the PP amount.

### Ethylene-Propylene Chain Structure

The specific EPDM may further have an ethylene-propylene chain structure.

The ethylene-propylene chain structure means a structure (unit) in which one repeating unit of ethylene and one repeating unit of propylene are continuous in EPDM.

The ethylene-propylene chain structure content (EP amount) is preferably from 30.0 to 60.0 mol %, and more preferably from 40.0 to 50.0 mol %, from the viewpoint of achieving more excellent effect of the present invention.

### Propylene-Propylene Chain Structure

The specific EPDM may further have a propylene-propylene chain structure.

The propylene-propylene chain structure means a structure (unit) including two continuous repeating units of propylene in EPDM.

The propylene-propylene chain structure content (PP amount) is preferably from 5.0 to 35.0 mol %, and more preferably from 5.0 to 15.0 mol %, from the viewpoint of achieving more excellent effect of the present invention.

### EE Amount/EP Amount

In the specific EPDM, a molar ratio (EE amount/EP amount) of the ethylene-ethylene chain structure to the ethylene-propylene chain structure is preferably 1.0 or more, and more preferably from 1.1 to 1.5, from the viewpoint of achieving more excellent effect of the present invention.

### Calculation of Diene Amount, EE Amount, and the Like of EPDM

In an embodiment of the present invention, the diene amount, EE amount, EP amount, and PP amount of the EPDM can be measured, quantified, and calculated using the following method by a nuclear magnetic resonance method using isotopic carbon (¹³C-NMR method).

### Analysis by ¹³C-NMR

Under the condition of 2048 times of accumulation (2 hours), ¹³C-NMR was measured by an inverse gate decoupling method.

As a sample for ¹³C-NMR measurement, a sample obtained by adding deuterochloroform to EPDM (before vulcanization) to swell it was used.

For chemical shift, the ¹³C signal of the deuterochloroform was set at 77 ppm, and the chemical shift of other ¹³C signals was used as a reference.

### Calculation of Diene Amount

From a total of integrated values (based on mass ratio) of all peaks in an integration range of from 51 ppm to 19 ppm of ¹³C-NMR and an integrated value (based on mass ratio) of a peak in an integration range of from 42.00 ppm to 40.60 ppm of ¹³C-NMR, the diene amount of the EPDM was calculated by the following equation.

$$Diene amount ( mass \% ) = A / B \times 100$$

A: an integrated value (based on mass ratio) of a peak in an integration range of from 42.00 ppm to 40.60 ppm
B: a total of integrated values (based on mass ratio) of all peaks in an integration range of 51 ppm to 19 ppm

### Calculation of EE Amount and the Like

In ¹³C-NMR, integration of a peak area was performed in each integration range (ppm) indicated below, and the EE amount, the EP amount, and the PP amount were determined by the following equation using each of the obtained integrated values. Each of the integrated values used in the calculation of the EE amount and the like are based on a molar ratio relative to a total integrated value of all chemical shifts included in a region of from 19 to 51 ppm (provided that an integrated value of a peak attributed to a structure derived from a conjugated diene (for example, derived from ENB) is excluded from the total integrated value).

$$EE amount ( mol \% ) = ( 9 ) \times 0.5 + 0.25 \times ( 8 ) + ( 11 ) \times 0.5$$

The above (9) represents an integrated value (based on molar ratio) of a peak area in an integration range of from 30.68 to 30.00 ppm.

The above (8) represents an integrated value (based on molar ratio) of a peak area in an integration range of from 31.00 to 30.68 ppm.

The above (11) represents an integrated value (based on molar ratio) of a peak area in an integration range of from 27.80 to 27.43 ppm.

$$EP amount ( mol \% ) = ( 2 )$$

The above (2) represents an integrated value (based on molar ratio) of a peak area in an integration range of from 39.80 to 35.60 ppm.

$$PP amount ( mol \% ) = ( 1 ) + ( E 1 ) - 4 \times ( E 2 )$$

The above (1) represents an integrated value (based on molar ratio) of a peak area in an integration range of from 49.00 to 42.00 ppm.

The above (E1) represents an integrated value (based on molar ratio) of a peak area in an integration range of from 51.00 to 49.00 ppm.

The above (E2) represents an integrated value (based on molar ratio) of a peak area in an integration range of from 42.00 to 40.60 ppm.

Symbols (E1) to (11) representing the integrated values of the peak areas in the respective integration ranges, attributions in the respective integration ranges, and the respective integration ranges (ppm) are collectively listed below.

Symbol: Attribution: Integration range (ppm)
(E1): ENB (C1E): from 51.00 to 49.00 ppm
(1): Sαα+ENB (C5+C6+C1Z): from 49.00 to 42.00 ppm
(E2): ENB (C4): from 42.00 to 40.60 ppm
(2): Sαγ+Sαδ: from 39.80 to 35.60 ppm
(8): Sγδ: from 31.00 to 30.68 ppm
(9): Sδδ: from 30.68 to 30.00 ppm
(11): Sβγ: from 27.80 to 27.43 ppm
ENB is 5-ethylidene-2-norbornene.

In the above attributions, S means methylene. The Greek letter indicates a position of a methylene carbon atom on the main chain between shortest two carbon atoms to which a methyl group is attached in the EPDM, and a carbon atom next to the carbon atom to which the methyl group is attached is a.

Examples of carbon notations are listed below.

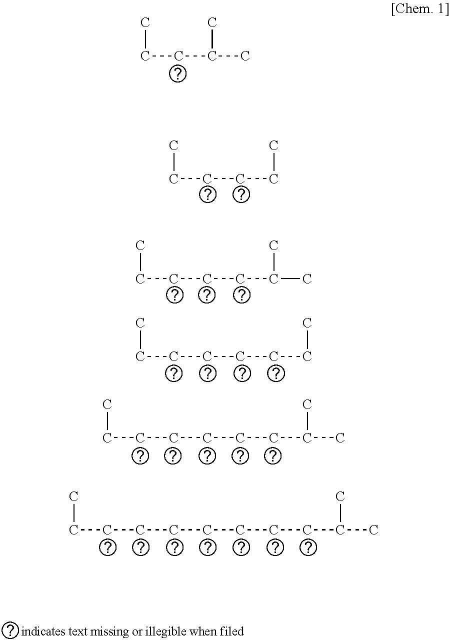

For the attributions of the EPDM and calculation of monomer ratio, diad ratio, and the like, for example, the following documents can be referred to.
1. Monomer Composition and Sequence Structure Analysis (NMR) of Ethylene-Propylene Elastomer (EPDM), Tosoh Technical Report: No. T1913/2019.12.4
2. Determination of Monomer Sequence Distribution in EPDM by 13C-NMR: Third Monomer Effects [Journal of Applied Polymer Science, Vol. 71, 523-530 (1999)]
3. U.S. Pat. No. 9,543,596 B2

### Weight Average Molecular Weight and Molecular Weight Distribution of Specific EPDM

A weight average molecular weight (Mw) of the specific EPDM is preferably 450000 or less, and more preferably from 300000 to 450000, from the viewpoint of achieving more excellent effect of the present invention.

A molecular weight distribution (Mw/Mn) of the specific EPDM is preferably from 8.0 to 2.0, and more preferably from 2.0 to 2.8, from the viewpoint of achieving more excellent effect of the present invention.

In the present specification, the weight average molecular weight, number average molecular weight, and molecular weight distribution of the EPDM are values in terms of standard polystyrene based on values as measured by gel permeation chromatography (GPC).

Measurement conditions for the weight average molecular weight and the like of the EPDM are as follows.
Measurement instrument: HLC-8020 (available from Tosoh Corporation)
Column: GMH-HR-H (available from Tosoh Corporation), two connected in serial
Detector: Differential refractometer RI-8020 (available from Tosoh Corporation)
Eluent: Tetrahydrofuran
Column temperature: 40° C.

### Content of Specific EPDM

In the present invention, the rubber component contains the specific EPDM in an amount of 40 mass % or more in the rubber component.

Due to the content of the specific EPDM being 40 mass % or more in the rubber component, excellent effect (particularly, ozone resistance) of the present invention is achieved.

From the viewpoint of achieving more excellent effect of the present invention, the rubber component preferably contains the specific EPDM in an amount of from 90 to 100 mass % in the rubber component, and the entire amount of the rubber component is more preferably the specific EPDM.

When the rubber component further contains a rubber component (additional rubber component) other than the specific EPDM, the additional rubber component is not particularly limited. Examples of the additional rubber component include diene rubbers, and more specific examples thereof include natural rubber; butadiene rubber; and aromatic vinyl-diene copolymers such as styrene-butadiene rubber.

In a case where the rubber component further contains an additional rubber component, the additional rubber component preferably includes a styrene-butadiene rubber (SBR) from the viewpoint of achieving more excellent effect (particularly, ozone resistance) of the present invention.

A content of the additional rubber component is preferably from 0 to 60 mass %, more preferably from 0 to 10 mass %, and still more preferably 0 mass % in the rubber component, from the viewpoint of achieving more excellent effect of the present invention.

### Carbon Black

The rubber composition according to an embodiment of the present invention contains carbon black.

### Iodine Adsorption

An iodine adsorption of the carbon black is preferably from 10 to 50 mg/g and more preferably from 15 to 50 mg/g, from the viewpoint of achieving more excellent effect of the present invention.

The iodine adsorption of the carbon black can be measured in accordance with JIS K 6217-1:2008.

### Nitrogen Adsorption Specific Surface Area

A nitrogen adsorption specific surface area (N₂ SA) of the carbon black is preferably from 0 to 130 m²/g and more preferably from 20 to 50 m²/g, from the viewpoint of achieving more excellent effect of the present invention.

The nitrogen adsorption specific surface area of the carbon black may be measured in accordance with JIS K6217-2:2008.

### Dibutyl Phthalate Oil Absorption

From the viewpoint of achieving more excellent effect of the present invention, the dibutyl phthalate (DBP) oil absorption of the carbon black is preferably from 0 to 140 ml/100 g, more preferably from 0 to 130 ml/100 g, and still more preferably from 40 to 130 ml/100 g.

The DBP oil absorption of the carbon black may be measured in accordance with JIS K6217-4:2008.

### Type of Carbon Black

The carbon black preferably contains at least one selected from the group consisting of SAF, ISAF, HAF, FEF, GPF, SRF, FT and MT carbon black, more preferably contains at least one selected from the group consisting of FEF, GPF, SRF, FT and MT carbon black, and still more preferably contains FEF and/or SRF carbon black, from the viewpoint of achieving more excellent effect of the present invention.

### Content of Carbon Black

A content of the carbon black is preferably 70 parts by mass or more, and more preferably from 70 to 100 parts by mass relative to 100 parts by mass of the rubber component, from the viewpoint of achieving more excellent effect of the present invention.

### Sulfur

The rubber composition according to an embodiment of the present invention contains sulfur.

Sulfur is not particularly limited, as long as it can be used for vulcanization of a rubber. Examples of such sulfur include known sulfur.

The form of sulfur is not particularly limited. Examples of the form of sulfur include oil-treated sulfur and powdery sulfur.

### Content of Sulfur

A content of sulfur (net content of sulfur) is preferably 0.65 parts by mass or more, and more preferably from 0.70 to 3.0 parts by mass relative to 100 parts by mass of the rubber component, from the viewpoint of achieving more excellent effect of the present invention.

### Additives

The rubber composition of the present invention may further contain an additive, as necessary, as long as the effect of the present invention is not impaired.

Examples of the additive include softening agents such as paraffin oil and naphthene oil; talc, silica; vulcanization accelerator aids (for example, stearic acid), zinc oxide, vulcanization retarders, vulcanization accelerators, and antioxidants.

As one preferred aspect, the rubber composition according to an embodiment of the present invention does not contain an ethylene-propylene copolymer (binary copolymer of ethylene and propylene). The ethylene-propylene copolymer does not correspond to the EPDM.

As one preferred aspect, the rubber composition of the present invention does not contain a peroxide.

### Method for Manufacturing Rubber Composition

The rubber composition according to an embodiment of the present invention is not particularly limited as to its manufacturing method. For example, the rubber composition can be manufactured by mixing the above-mentioned essential components and optional components that can be used if necessary, under the condition of from 100 to 180° C.

### Vulcanization of Rubber Composition

The method for vulcanizing (sulfur-vulcanizing) the rubber composition according to an embodiment of the present invention is not particularly limited. The rubber composition according to an embodiment of the present invention can be vulcanized under the condition of from 140 to 190° C., for example. Specific examples of the vulcanization method include press vulcanization, steam vulcanization, oven vulcanization (dry heat vulcanization), and hot water vulcanization. A cured product (vulcanized rubber) can be obtained by vulcanizing the rubber composition according to an embodiment of the present invention.

### Intended Use

The rubber composition according to an embodiment of the present invention can be applied to, for example, a hose.

Examples of the hose include a hose for an air conditioner. Specific examples of the hose include a hose for a car air conditioner.

The rubber composition according to an embodiment of the present invention is preferably applied to an outermost layer of the hose.

### Hose

The hose according to an embodiment of the present invention is a hose formed by using the rubber composition for the hose according to an embodiment of the present invention.

The hose according to an embodiment of the present invention is not particularly limited, as long as the hose is formed by using the rubber composition according to an embodiment of the present invention. The rubber composition used in the hose according to an embodiment of the present invention is not particularly limited, as long as it is the rubber composition according to an embodiment of the present invention. It is not particularly limited on which member of the hose according to an embodiment of the present invention is formed by the rubber composition according to an embodiment of the present invention.

### Outermost Layer

The hose according to an embodiment of the present invention preferably includes an outermost layer formed by the rubber composition according to an embodiment of the present invention.

A thickness of the outermost layer can be, for example, from 0.2 to 4 mm.

In addition to the outermost layer, the hose according to an embodiment of the present invention may further include at least one selected from the group consisting of a reinforcing member (reinforcing layer), an innermost layer, and an intermediate rubber layer. The outermost layer may be one layer or a plurality of layers. The same applies to the innermost layer, the reinforcing member, and the intermediate rubber layer.

The hose according to an embodiment of the present invention can include, for example, the innermost layer, the reinforcing member, and the outermost layer in this order.

### Innermost Layer

The innermost layer that the hose according to an embodiment of the present invention can include is not particularly limited. Examples of the innermost layer include known innermost layers.

A thickness of the innermost layer can be, for example, from 0.2 to 4 mm.

### Reinforcing Member

The reinforcing member that the hose according to an embodiment of the present invention can include is not particularly limited. Examples of the reinforcing member include known reinforcing members.

Examples of the material for the reinforcing member include metals and fiber materials (e.g., polyamide and polyester). The reinforcing member may be a surface-treated reinforcing member.

Examples of the form of the reinforcing member include those braided into a spiral structure and/or a braid structure.

An example of the hose according to an embodiment of the present invention will be described with reference to the accompanying drawings. However, the present invention is not limited to the attached drawings.

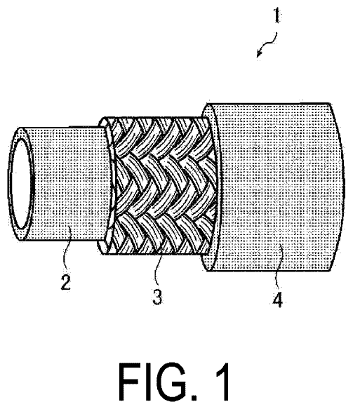

FIG. 1 is a schematic perspective view showing an example of a hose according to an embodiment of the present invention with each layer cut out.

In FIG. 1, a hose 1 includes an innermost layer 2, a reinforcing member 3 on the innermost layer 2, and an outermost layer 4 on the reinforcing member 3. As one preferred aspect, the outermost layer 4 is formed by the rubber composition according to an embodiment of the present invention.

The hose according to an embodiment of the present invention is not particularly limited as to its manufacturing method. For example, the hose according to an embodiment of the present invention can be manufactured by stacking a rubber composition for forming an innermost layer, a reinforcing member, and a rubber composition for forming an outermost layer (e.g., rubber composition according to an embodiment of the present invention) in this order on a mandrel to form a multilayer structure, covering the multilayer structure with a nylon cloth or the like, and vulcanizing and bonding the multilayer structure with the nylon cloth or the like by press vulcanization, steam vulcanization, oven vulcanization (dry heat vulcanization) or hot water vulcanization under the conditions of a temperature of from 140 to 190° C. and a period of from 30 to 180 minutes.

Examples of the intended use of the hose according to an embodiment of the present invention include a hose for an air conditioner. Specific examples of the intended use include a hose for a car air conditioner.

### EXAMPLES

An embodiment of the present invention will be described below in detail by way of examples. However, an embodiment of the present invention is not limited to such examples.

### Structure of Rubber Composition

Using each component respectively listed in each of the following tables in the compositions (part by mass) listed in the same tables, rubber compositions were manufactured by mixing the components with an agitator.

Specifically, master batches were obtained by first mixing the components listed in the following tables, except for a vulcanization accelerator and an oil-treated sulfur, for 5 minutes in a (3.4-L) Banbury mixer, and then discharging the mixture when the temperature reached 160° C.

Next, a vulcanization accelerator and oil-treated sulfur were added to each of the masterbatches obtained as described above, they were mixed using an open roll, and thus a rubber composition was obtained.

In Table 1, EPDM and SBR were used as the rubber components.

In Table 2, EPDM was used as the rubber component.

### Production of Vulcanized Sheet

Using a 153° C. press molding machine, each of the rubber compositions obtained as described above was vulcanized for 45 minutes under a surface pressure of 3.0 MPa, and thus a vulcanized sheet having a thickness of 2 mm was produced.

### Evaluation

### Elongation at Break

First, a JIS No. 3 dumbbell-shaped test piece in accordance with JIS K6251 was punched out from each of the vulcanized sheets, and an initial test piece was obtained.

Next, using each of the initial test pieces described above, a tensile test was performed under the condition of 23° C.±2° C. and a tensile speed of 500 mm/min in accordance with JIS K6251:2010, and elongation at break (EB) [%] was measured.

In Table 1, results of the elongation at break were expressed as indexes based on the result of Comparative Example 1 containing comparative EPDM1 as EPDM being 100. In Table 2, the results are expressed as indexes based on the result of Comparative Example 6 containing the comparative EPDM1 as EPDM being 100.

The evaluation criteria for elongation at break are as follows.

When the elongation at break (index) was 107 or more, the elongation at break of the obtained cured product was evaluated as excellent. As hardness (index) is more than 107, the elongation at break of the obtained cured product is more excellent.

On the other hand, when the elongation at break (index) was less than 107, the elongation at break of the obtained cured product was evaluated as poor.

### Hardness

First, three vulcanized sheets obtained as described above (Production of Vulcanized Sheet) were layered, and an initial test piece was obtained.

A hardness measurement test was performed under the condition of 23° C. using a type A durometer in accordance with JIS K6253-3:2012, and the hardness of each of the initial test pieces obtained as described above was measured.

Results of the hardness are expressed as indexes based on the result of Comparative Example 1 being 100 in Table 1, and expressed as indexes based on the result of Comparative Example 6 being 100 in Table 2.

The evaluation criteria for hardness are as follows.

When the hardness (index) was 100 or more, the hardness of the obtained cured product was evaluated as excellent. As hardness (index) is more than 100, the hardness of the obtained cured product is more excellent.

When the hardness (index) was less than 100, the hardness of the obtained cured product was evaluated as poor.

### Ozone Resistance

A JIS No. 3 dumbbell-shaped test piece in accordance with JIS K6251 was cut from each of the obtained vulcanized sheets obtained as described above (Production of Vulcanized Sheet).

Next, each of the test pieces was elongated by 30% and subjected to ozone deterioration for 72 hours under the conditions of an ozone concentration of 100 pphm and 50° C., and then the presence or absence of ozone cracks at the surfaces of the test pieces was visually evaluated.

The obtained results are listed on the “Ozone resistance” rows of the tables.

The evaluation criteria for ozone resistance are as follows.

When there was no ozone crack in the surface of the test piece, the ozone resistance was evaluated to be excellent and indicated as “no crack”.

On the other hand, when ozone cracks were found in the surface of the test piece, the ozone resistance was evaluated as poor, and this case is indicated as “cracked”.

TABLE 1

| | | | | | EE | Compar- | Compar- | Compar- | | | Compar- | Compar- |
|---|---|---|---|---|---|---|---|---|---|---|---|---|
| | Diene | EE | EP | PP | amount/ | ative | ative | ative | | | ative | ative |
| | amount | amount | amount | amount | EP | Exam- | Exam- | Exam- | Exam- | Exam- | Exam- | Exam- |
| | mass % | mol % | mol % | mol % | amount | ple 1 | ple 2 | ple 3 | ple 1 | ple 2 | ple 4 | ple 5 |
| Comparative EPDM1 | 8 | 28.9 | 56.4 | 14.7 | 0.51 | 40 | | | | | | |
| Keltan 6950C | | | | | | | | | | | | |
| (CHINA) | | | | | | | | | | | | |
| Comparative EPDM2 | 9 | 30.2 | 55.7 | 14.1 | 0.54 | | 40 | | | | 30 | |
| Keltan 6950C | | | | | | | | | | | | |
| (Netherlands) | | | | | | | | | | | | |
| Comparative EPDM3 | 11 | 32.8 | 48.9 | 18.3 | 0.67 | | | 40 | | | | |
| EPT9090M | | | | | | | | | | | | |
| EPDM1 | 9 | 39.7 | 54.7 | 5.6 | 0.73 | | | | 40 | | | 30 |
| KEP370F | | | | | | | | | | | | |
| EPDM2 | 7 | 49.7 | 41.1 | 9.2 | 1.21 | | | | | 40 | | |
| 4110M | | | | | | | | | | | | |
| SBR | — | — | — | — | — | 60 | 60 | 60 | 60 | 60 | 70 | 70 |
| FEF Carbon black | — | — | — | — | — | 72 | 72 | 72 | 72 | 72 | 72 | 72 |
| Naphthene oil | — | — | — | — | — | 21 | 21 | 21 | 21 | 21 | 21 | 21 |
| Zinc oxide | — | — | — | — | — | 5 | 5 | 5 | 5 | 5 | 5 | 5 |
| Vulcanization | — | — | — | — | — | 1.6 | 1.6 | 1.6 | 1.6 | 1.6 | 1.6 | 1.6 |
| accelerator CZ | | | | | | | | | | | | |
| Oil-treated sulfur | — | — | — | — | — | 2 | 2 | 2 | 2 | 2 | 2 | 2 |
| Elongation at break (index) | | | | | | 100 | 103 | 100 | 108 | 121 | 104 | 110 |
| Hardness (index) | | | | | | 100 | 100 | 101 | 100 | 101 | 99 | 100 |
| Ozone resistance | 100 pphm × 50° C. × 30% elongation × 72 hr | | | | | No | No | No | No | No | Cracked | Cracked |
| (index) | | | | | | cracks | cracks | cracks | cracks | cracks | | |

TABLE 2

| | | | | | | Compar- | Compar- | Compar- | | |
|---|---|---|---|---|---|---|---|---|---|---|
| | Diene | EE | EP | PP | EE | ative | ative | ative | | |
| | amount | amount | amount | amount | amount/EP | Exam- | Exam- | Exam- | Exam- | Exam- |
| | mass % | mol % | mol % | mol % | amount | ple 6 | ple 7 | ple 8 | ple 3 | ple 4 |
| Comparative EPDM1 | 8 | 28.9 | 56.4 | 14.7 | 0.51 | 100 | | | | |
| Keltan 6950C (CHINA) | | | | | | | | | | |
| Comparative EPDM2 | 9 | 30.2 | 55.7 | 14.1 | 0.54 | | 100 | | | |
| Keltan 6950C (Netherlands) | | | | | | | | | | |
| Comparative EPDM3 | 11 | 32.8 | 48.9 | 18.3 | 0.67 | | | 100 | | |
| EPT9090M | | | | | | | | | | |
| EPDM1 | 9 | 39.7 | 54.7 | 5.6 | 0.73 | | | | 100 | |
| KEP370F | | | | | | | | | | |
| EPDM2 | 7 | 49.7 | 41.1 | 9.2 | 1.21 | | | | | 100 |
| 4110M | | | | | | | | | | |
| SRF Carbon black | — | — | — | — | — | 87 | 87 | 87 | 87 | 87 |
| Talc | — | — | — | — | — | 30 | 30 | 30 | 30 | 30 |
| Paraffin oil | — | — | — | — | — | 40 | 40 | 40 | 40 | 40 |
| pvi | — | — | — | — | — | 0.3 | 0.3 | 0.3 | 0.3 | 0.3 |
| Zinc oxide | — | — | — | — | — | 5 | 5 | 5 | 5 | 5 |
| Stearic acid | — | — | — | — | — | 1 | 1 | 1 | 1 | 1 |
| Vulcanization accelerator TET | — | — | — | — | — | 0.5 | 0.5 | 0.5 | 0.5 | 0.5 |
| Vulcanization accelerator TRA | — | — | — | — | — | 0.5 | 0.5 | 0.5 | 0.5 | 0.5 |
| Vulcanization accelerator TT | — | — | — | — | — | 0.5 | 0.5 | 0.5 | 0.5 | 0.5 |
| Vulcanization accelerator DM | — | — | — | — | — | 0.7 | 0.7 | 0.7 | 0.7 | 0.7 |
| Oil-treated sulfur | — | — | — | — | — | 0.8 | 0.8 | 0.8 | 0.8 | 0.8 |

| Elongation at break (index) | | 100 | 105 | 110 | 116 | 120 |
|---|---|---|---|---|---|---|
| Hardness (index) | | 100 | 100 | 99 | 102 | 104 |
| Ozone resistance (index) | 100 pphm × 50° C. × 30% elongation × 72 hr | No cracks | No cracks | No cracks | No cracks | No cracks |

The details of each component listed in each table are as follows.

### Rubber Component

Comparative EPDM1, Keltan 6950C (CHINA): ethylene-propylene-non-conjugated diene copolymer having a diene amount of 8 mass % and an EE amount of 28.9 mol %. Available from LANXESS.
Comparative EPDM2, Keltan 6950C (Netherlands): ethylene-propylene-non-conjugated diene copolymer having a diene amount of 9 mass % and an EE amount of 30.2 mol %. Available from LANXESS.
Comparative EPDM3, EPT9090M: ethylene-propylene-non-conjugated diene copolymer having a diene amount of 11 mass % and an EE amount of 32.8 mol %. Available from Mitsui Chemicals, Inc.

### Ethylene-Propylene-Non-Conjugated Diene Copolymer

EPDM1, KEP370F: ethylene-propylene-non-conjugated diene copolymer having a diene amount of 9 mass % and an EE amount of 39.7 mol %. EE amount/EP amount: 0.73. Weight average molecular weight: 150000, molecular weight distribution: 7.7. Non-conjugated diene: 5-ethylidene-2-norbornene. Available from KUMHO
EPDM2, 4110M: ethylene-propylene-non-conjugated diene copolymer having a diene amount of 7 mass % and an EE amount of 49.7 mol %. EE amount/EP amount: 1.21. Weight average molecular weight: 449000, molecular weight distribution: 2.3. Non-conjugated diene: 5-ethylidene-2-norbornene. Available from SSME
SBR: Styrene-butadiene rubber. Trade name: Nipol 1502, available from Zeon Corporation

### Carbon Black

FEF Carbon black: trade name: NITERON #10N, available from Nippon Steel Chemical Carbon Co., Ltd. Iodine adsorption: 41±4 mg/g, N₂ SA: 42±4 m²/g, DBP oil absorption: 121±6 ml/100 g.
SRF Carbon black: trade name: Asahi #50, available from Asahi Carbon Co., Ltd. Iodine adsorption: 20±5 mg/g, N₂ SA: 25±5 m²/g, DBP oil absorption: from 55 to 79 ml/100 g.
Talc: trade name MISTRON VAPOR, available from Imerys
Naphthenic oil: trade name CoumorexH22, available from JXTG Energy Corporation
Paraffin oil: trade name: SUNPAR 2280. Available from Japan Sun Oil Company, Ltd.
pvi: vulcanization retarder. N-(cyclohexylthio)phthalimide. Trade name: Retarder CTP, available from Toray Fine Chemical Co., Ltd.
Zinc oxide: Zinc Oxide III, available from Seido Chemical Industry Co., Ltd.
Stearic acid: stearic acid 50S, available from Chiba Fatty Acid Co., Ltd.
Vulcanization accelerator CZ: N-cyclohexyl-2-benzothiazolylsulfenamide. Sulfenamide-based. NOCCELER CZ-G, available from Ouchi Shinko Chemical Industrial Co., Ltd.
Vulcanization accelerator TET: tetraethylthiuram disulfide. Thiuram-based. NOCCELER TET-G, available from Ouchi Shinko Chemical Industrial Co., Ltd.
Vulcanization accelerator TRA: dipentamethylenethiuramtetrasulfide. Thiuram-based. NOCCELER TRA, available from Ouchi Shinko Chemical Industrial Co., Ltd.
Vulcanization accelerator TT: tetramethylthiuram disulfide. Thiuram-based. NOCCELER TT, available from Ouchi Shinko Chemical Industrial Co., Ltd.)
Vulcanization accelerator DM: dibenzothiazyl disulfide. Thiazole-based. Sanceller DM, available from Sanshin Chemical Industry Co., Ltd.

### Sulfur

Oil-treated sulfur: available from Hosoi Chemical Industry Co., Ltd. The oil-treated sulfur contains sulfur. A concentration of the sulfur in the oil-treated sulfur is 95 mass %.

From the results indicated in Table 1, Comparative Examples 1 to 3 containing EPDM having an EE amount of less than 35.0 mol % were poor in elongation at break.

Comparative Example 4 in which the content of the EPDM having an EE amount of less than 35.0 mol % was 30 mass % in the rubber component was poor in elongation at break, hardness, and ozone resistance.

Comparative Example 5 in which the content of the specific EPDM was less than 40 mass % in the rubber component was poor in ozone resistance.

From the results indicated in Table 2, Comparative Examples 6 to 8 containing EPDM having an EE amount of less than 35.0 mol % were poor in elongation at break or the hardness.

On the other hand, the rubber compositions of the present invention were excellent in elongation at break, hardness, and ozone resistance of the resulting cured product.

### REFERENCE SIGNS LIST

1 Hose
2 Innermost layer
3 Reinforcing member
4 Outermost layer

1. A rubber composition, comprising:
a rubber component comprising 40 mass % or more of an ethylene-propylene-non-conjugated diene copolymer containing a diene amount of 6 mass % or more and an ethylene-ethylene chain structure content of 35.0 mol % or more;
carbon black; and
sulfur.

2. The rubber composition according to claim 1, wherein a molar ratio of the ethylene-ethylene chain structure to an ethylene-propylene chain structure of the ethylene-propylene-non-conjugated diene copolymer is 1.0 or more.

3. The rubber composition according to claim 1, wherein an entire amount of the rubber component is the ethylene-propylene-non-conjugated diene copolymer.

4. The rubber composition according to claim 1, wherein
a content of the carbon black is 70 parts by mass or more relative to 100 parts by mass of the rubber component, and
a content of the sulfur is 0.65 parts by mass or more relative to 100 parts by mass of the rubber component.

5. The rubber composition according to claim 1, which is for a hose.

6. A hose formed by using the rubber composition according to claim 1.

7. The hose according to claim 6, which is for an air conditioner.

8. The hose according to claim 6, comprising an outermost layer formed by using the rubber composition.
